(19) United States
(12) Patent Application Publication
(10) Pub. No.: US 2024/0256716 A1
(43) Pub. Date: Aug. 1, 2024

(54) DATA ACCESS METHOD, RELATED DEVICE, AND STORAGE MEDIUM

(71) Applicant: Nanjing SemiDrive Technology LTD., Nanjing (CN)

(72) Inventors: XIONGFEI LIU, Nanjing (CN); QIAOYU YE, Nanjing (CN); LIHANG ZHANG, Nanjing (CN); SHAOHUI GONG, Nanjing (CN); JUN PENG, Nanjing (CN)

(21) Appl. No.: 18/423,921

(22) Filed: Jan. 26, 2024

(30) Foreign Application Priority Data
Jan. 30, 2023 (CN) 202310066725.X

(51) Int. Cl. G06F 21/78; G06F 21/60

(52) U.S. Cl. CPC G06F 21/78; G06F 21/604

(57) ABSTRACT

A data access method includes obtaining a data access request for M storage devices, M being an integer greater than or equal to 2, determining a target access mode for the M storage devices based on the data access request, and performing data access on the storage devices based on access control signals matching the target access mode for the storage devices. The target access mode includes a first access mode and a second access mode. Access security and/or access speed generated when the data access is performed on the storage devices in the first access mode is different from access security and/or access speed generated in the second access mode.

### CROSS-REFERENCE TO RELATED APPLICATION

The present disclosure claims priority to Chinese Patent Application No. 202310066725.X, filed on Jan. 30, 2023, the entire content of which is incorporated herein by reference.

### TECHNICAL FIELD

The present disclosure generally relates to the communication technology field and, more particularly, to a data access method, a related device, and a storage medium.

### BACKGROUND

In the related technology, hardware such as a Flash drive, a hard drive, an optical disk, etc., are used as storage devices due to their respective advantages. For example, a Flash drive has the advantage of not losing data during power loss, a hard drive has the advantage of large storage capacity, and an optical disk has the advantage of a long lifecycle. When an access device accesses the storage devices or one of the storage devices, the access device needs to perform data access (read and write data) based on the read and write performance of the storage device. That is, the access device accessing to the storage device is limited by the read and write performance of the storage device. It is desired to effectively access the storage device without changing the read and write performance of the storage device.

### SUMMARY

Embodiments of the present disclosure provide a data access method. The method includes obtaining a data access request for M storage devices, M being an integer greater than or equal to 2, determining a target access mode for the M storage devices based on the data access request, and performing data access on the storage devices based on access control signals matching the target access mode for the storage devices. The target access mode includes a first access mode and a second access mode. Access security and/or access speed generated when the data access is performed on the storage devices in the first access mode is different from access security and/or access speed generated in the second access mode.

Embodiments of the present disclosure provide a data access device, including one or more processors and one or more memories. The one or more memories are communicatively connected to the one or more processors and store an instruction that, when executed by the one or more processors, causes the one or more processors to obtain a data access request for M storage devices, M being an integer greater than or equal to 2, determine a target access mode for the M storage devices based on the data access request, and perform data access on the storage devices based on access control signals matching the target access mode for the storage devices. The target access mode includes a first access mode and a second access mode. Access security and/or access speed generated when the data access is performed on the storage devices in the first access mode is different from access security and/or access speed generated in the second access mode.

Embodiments of the present disclosure provide a non-transitory computer-readable storage medium storing an instruction that, when executed by one or more processors, causes the one or more processors to obtain a data access request for M storage devices, M being an integer greater than or equal to 2, determine a target access mode for the M storage devices based on the data access request, and perform data access on the storage devices based on access control signals matching the target access mode for the storage devices. The target access mode includes a first access mode and a second access mode. Access security and/or access speed generated when the data access is performed on the storage devices in the first access mode is different from access security and/or access speed generated in the second access mode.

In the present disclosure, without changing the read and write performance of the storage device, effective access to two or more storage devices can be realized using the targeted access mode and access control signals matching the targeted access mode for the storage devices.

The description of the present disclosure is not intended to indicate the key or important features of embodiments of the present disclosure and limit the scope of the present disclosure. Other features of the present disclosure become understandable through the description below.

### BRIEF DESCRIPTION OF THE DRAWINGS

The following drawings are merely examples for illustrative purposes according to various disclosed embodiments and are not intended to limit the scope of the present disclosure.

FIG. 1 illustrates a schematic flowchart of a data access method according to some embodiments of the present disclosure.

FIG. 2 illustrates a schematic diagram showing a data access device accessing a storage device according to some embodiments of the present disclosure.

FIG. 3 illustrates a schematic diagram showing a time sequence of accessing a storage device in a high-security access mode according to some embodiments of the present disclosure.

FIG. 4 illustrates another schematic diagram showing a data access device accessing a storage device according to some embodiments of the present disclosure.

FIG. 5 illustrates another schematic diagram showing a time sequence of accessing a storage device in a high-speed access mode according to some embodiments of the present disclosure.

FIG. 6 illustrates another schematic diagram showing a data access device accessing a storage device according to some embodiments of the present disclosure.

FIG. 7 illustrates a schematic diagram showing hardware of a data access device according to some embodiments of the present disclosure.

FIG. 8 illustrates a schematic diagram of performing area division on the storage device according to some embodiments of the present disclosure.

FIG. 9 illustrates another schematic diagram of performing area division on a storage device according to some embodiments of the present disclosure.

FIG. 10 illustrates a schematic structural diagram of a data access device according to some embodiments of the present disclosure.

FIG. 11 illustrates another schematic structural diagram of a data access device according to some embodiments of the present disclosure.

### DETAILED DESCRIPTION OF THE EMBODIMENTS

To make the purpose, features, and advantages of the present disclosure more apparent and understandable, the technical solution of embodiments of the present disclosure is described in detail in connection with the accompanying drawings of embodiments of the present disclosure. The described embodiments are only some embodiments of the present disclosure, not all embodiments. Based on embodiments of the present disclosure, all other embodiments obtained by those skilled in the art without creative efforts are within the scope of the present disclosure.

To make the purpose, technical solution, and advantages of the present disclosure clearer, the present disclosure is further described in detail in connection with the accompanying drawings. The described embodiments should not be regarded as limitations of the present disclosure, and all other embodiments obtained by those skilled in the art without creative efforts are within the scope of the present disclosure.

In the following description, “some embodiments” describes a subset of all possible embodiments and can be the same subset or different subsets of all possible embodiments, which can be combined with each other when there is no conflict.

In the following description, the terms “first” and “second” are only used to distinguish similar objects and do not represent a specific order for the objects. The order or sequence of “first” and “second” can be interchanged in an allowed situation. Thus, embodiments of the present disclosure can be implemented in another sequence other than the sequence described in the drawings.

Unless otherwise defined, all technical and scientific terms used here have the same meanings as those commonly understood by those skilled in the art. The terms used here are only for the purpose of describing embodiments of the present disclosure and are not intended to limit the present disclosure.

In various embodiments of the present disclosure, the values of the sequence numbers of processes do not imply a specific execution sequence. The execution sequence of the processes should be determined based on the functionality and inherent logic of the processes and should not limit the implementation process of embodiments of the present disclosure.

The processing logic of the data access method of embodiments of the present disclosure can be deployed in any appropriate device. The device can be any device that can access or needs to access the data stored in the storage device, such as a driving device, a terminal, a server, etc. The driving device can include at least one of a private traveling tool or a public traveling tool. The private travel tool can include but is not limited to a balance car, an electric motorcycle, a private car, a private plane, etc. The public travel tool can include but is not limited to a bus, a train, a subway, a high-speed train, an airplane, etc. The terminal can include but is not limited to an on-board terminal, a tablet computer, an all-in-one computer, a desktop computer, etc. The server can include a general server, a cloud server, a server for a specialized field such as the automotive field, etc.

The technical solution of the present disclosure is described in detail below.

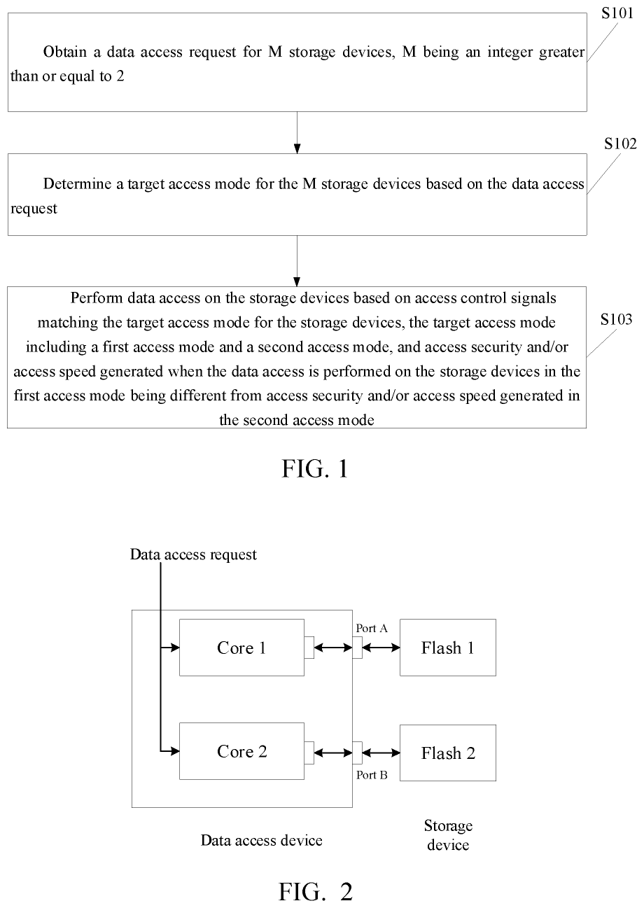

FIG. 1 illustrates a schematic flowchart of a data access method according to some embodiments of the present disclosure. The method can be applied to a data access device. As shown in FIG. 1, the method includes the following steps.

At S101, a data access request is obtained for M storage devices, where M is a positive integer greater than or equal to 2.

In some embodiments, two or more storage devices are provided. The two or more storage devices can be of the same type or different types. The types of storage devices can include but are not limited to a Flash drive (Flash), a hard drive, an optical disk, etc. In some embodiments, the two or more storage devices can be of the same type, such as Flash-type storage devices or hard drive-type storage devices.

In some embodiments, the M storage devices can be treated as a whole, and the data access request can be a single access request for requesting access to the whole. That is, the M storage devices can correspond to one access request. The access request for the storage device can be used to request writing data into or reading data from the storage device.

In some embodiments, obtaining the data access request for the M storage devices can include but is not limited to at least one of generating the data access request for the M storage devices when the access device has a data access need for the storage devices, or obtaining the data access request for the M storage devices by receiving the data access request from an external device. The external device can send the data access request to the access device when having the access request for the storage devices.

At S102, based on the data access request, a target access mode is determined for the M storage devices.

In some embodiments, access modes of the M storage devices can include a first access mode and a second access mode. The two access modes can have different access securities, one with high access security, and the other one with low access security. These two access modes can also have different access speeds, one with fast access speed, and the other one with slow access speed. The first access mode and the second access mode can be different at least from one of the access security and the access speed. In some embodiments, in the two access modes, one access mode can have higher security than the other access mode, or one access mode can have a faster speed than the other access mode, or one access mode can have higher security and the faster speed than the other access mode.

In theory one access mode of the two access modes can be designed to have higher security and a faster speed through a specific preparation process or processing process. In some embodiments, considering the complexity of the preparation process and the difficulty of the processing process, trade-offs can be performed on the security and the speed. That is, one access mode of the two access modes can have high security and may not have a fast access speed. In some other embodiments, one access mode of the two access modes can have fast access speed and may not have high security. Based on this, one access mode of the two access modes of the present disclosure can have high security and slow access speed. The other access mode of the two access modes of the present disclosure can have low security and a fast access speed.

The terms “high” and “low” for the access security and the access speed are relative to each other and not absolute.

In some embodiments, if one access mode of the two access modes is a high-security access mode, the other access mode can be a high-speed access mode, and vice versa. To facilitate description, the first access mode can be a high-security access mode, and the second access mode can be a high-speed access mode. The access security in the high-security access mode can be higher than the access security in the high-speed access mode. The access speed in the high-speed access mode can be higher than the access speed in the high-security access mode.

Thus, When the data access request is a single access request for the M storage devices, whether the target access mode is the first access mode or the second access mode can be determined under the access request based on the single access request for the M storage devices. All M storage devices can be under the same access request. The adopted target access mode can be one access mode of the two access modes.

In some embodiments, the data access request can include access addresses of the M storage devices. The target access mode of the M storage devices can be determined based on attributes of the access addresses to determine the steps of the target access mode of the M storage devices based on the data access request.

For example, if the attribute of the access address indicates that the access address can be accessed in the first access mode, the target access mode can be then determined to be the first access mode. If the attribute of the access address indicates that the access address can be accessed in the second access mode, the target access mode can be determined to be the second access mode. The solution of determining the access mode based on the attribute of the access address in the data access request is practical, highly feasible, and easy to implement.

In embodiments of the present disclosure, the attribute of the access address can be obtained by dividing the storage areas of the storage devices into at least two categories. Storage areas of a first category can correspond to the first access mode, and storage areas of a second category can correspond to the second access mode. At a technical level, the storage devices can be pre-divided into a high-security area and a high-speed area. Storage addresses within the high-security area of the storage device can be accessed in the high-security access mode, while storage addresses within the high-speed area of the storage device can be accessed in the high-speed access mode.

Taking any one storage device of the M storage devices as an example, based on the area in which the storage addresses are located in the storage device, the attributes of the storage addresses in that storage device can be obtained. If a storage address is in a high-security area in the storage device, the storage address can be configured with attribute information indicating that the storage address can be accessed in the high-security access mode. If the storage address is in the high-speed area in the storage device, the storage address can be configured with attribute information indicating that the storage address can be accessed in the high-speed access mode. Thus, the storage addresses can be configured with attributes in the storage devices, and the attributes configured for the storage addresses of the storage devices can be stored, which can be read when needed.

In some embodiments, for the access address included in the data access request, the access address can be used as the storage address of the storage device that the access device wants to access, and the attribute information configured for the storage address that needs to be accessed can be read. If the read attribute information indicates that the storage address can be accessed in the high-security access mode, the target access mode can be determined to be the high-security access mode. If the read attribute indicates that the storage address can be accessed in the high-speed access mode, the target access mode can be determined to be the high-speed access mode.

The above solution is described based on the attribute of the access address and through an example by dividing the storage areas of the storage devices into at least two categories. Once the storage areas of the storage devices are pre-divided into at least two types, whether the storage addresses of the storage devices are accessed in the high-security access mode or the high-speed access mode can be fixed. Thus, in the solution, the attributes of the storage addresses can be fixed. The solution of configuring fixed attribute information for the access addresses can be suitable for the situation of dividing the storage device into fixed areas, is practical, easy to implement, and feasible.

Different from the solution of dividing the storage areas of the storage devices into at least two types to obtain the attributes of the storage addresses or the access addresses, in some embodiments, the storage areas of the storage devices may not need to be divided, and the attribute of the access address can be obtained according to the history access mode used to access the access address. That is, the attribute of the access address can be determined through the history access mode of the access address. If the first access mode is used for the nearest one time or a plurality of times of accessing the access address of the storage device, the access address of the storage device can be configured with the attribute information indicating that the access address can be subsequently accessed in the first access mode. If the second access mode is used for the nearest one time or a plurality of times of accessing the access address of the storage device, the access address of the storage device can be configured with the attribute information indicating that the access address can be subsequently accessed in the second access mode.

That is, for the accessed storage address, the attribute information configured for the accessed storage address can be determined according to the actual access mode for the nearest one time or a plurality of times of accessing the storage address. The access mode used for subsequently accessing the storage address can be consistent with the access mode used for the nearest one time or a plurality of times of accessing the storage address. Compared to the fixed attribute information of the storage address, this solution can be considered as a solution of flexibly configuring the attribute information for the storage address. The flexible configuration solution can be used for the situations of the same storage address being used as different types of addresses at different moments (changing from an address in the high-security access mode to an address in the high-speed access mode, or vice versa), and is flexible and practical.

For example, if the storage areas of the storage devices are fixedly divided, and the access addresses included in the data access request are 0010 to 00A0, i.e., storage addresses 0010 to 00A0 need to be accessed in the storage devices, the stored attribute information configured for the storage addresses can be read. If the attribute information indicates that the storage addresses can be accessed in the high-speed access mode, the target access mode can be determined to be the high-speed access mode. If the attribute information indicates that the storage addresses can be accessed in the high-security access mode, the target access mode can be determined as the high-security access mode.

If the storage areas of the storage devices are not divided, and the access addresses included in the data access request are 0010 to 00A0, i.e., storage addresses 0010 to 00A0 need to be accessed in the storage devices, the attribute information of the storage addresses can be configured according to the access mode used for the nearest one time or a plurality of times of accessing 0010 to 00A0 to determine the target access mode. Further, if the access mode used for the nearest one time or a plurality of times of accessing 0010 to 00A0 is the high-security access mode, the target access mode can be determined as the high-security access mode. If the access mode used for the nearest one time or a plurality of times of accessing 0010 to 00A0 is the high-speed access mode, the target access mode can be determined as the high-speed access mode.

No matter based on the flexible configuration solution or fixed configuration solution of the attribute information, the target access mode can be determined based on the attributes of the access addresses included in the data access request, which can ensure the accuracy of determining the target access mode to smoothly access the storage devices.

At S103, based on access control signals matching the target access mode for the storage devices, data access is performed on the storage devices. The target access mode includes the first access mode and the second access mode. The access security and/or access speed generated when accessing the storage devices in the first access mode are different from the access security and/or access speed generated in the second access mode.

In some embodiments, one storage device can correspond to an access control signal. With different access modes, the access control signal for the same storage device can be the same or different. In two different access modes, there are corresponding access control signals for the storage devices. Data access can be performed on the storage devices according to the access control signals of the storage devices corresponding to the target access mode. The access control signals of the storage devices corresponding to the target access mode can be the access control signals of the storage devices matching the target access mode. The access control signals of the storage devices in different access modes can be pre-designed according to the actual access situations for the storage devices in the different access modes. The design process is not described in detail. The process of performing data access using the designed access control signals is described below.

The storage devices can be accessed using the access control signals of the storage devices matching the target access mode. Thus, the storage devices can be accessed smoothly and effectively.

In steps S101 to S103, two or more storage devices are accessed. The first access mode and the second access mode with different access securities and/or access speeds can be configured for access to the storage devices. Based on the data access request, the access mode for the storage devices can be determined. Then, based on the access control signals for the storage devices matching the access modes determined for the storage devices, the data access can be performed on the storage devices. Without changing the read and write performance of the storage devices, the target access modes and the access control signals matching the target access modes for the storage devices can be used to access the storage devices effectively.

In addition, using the target access modes and the target access control signals to access the two or more storage devices can improve the access effectivity for the storage devices compared to access to a single storage device.

Then, by taking the first access mode being the high-security access mode, the second access mode being the high-speed access mode, and the M storage devices being two storage devices (a first storage device and a second storage device) as an example, similarities and differences are described for the two access modes below.

First, for the access modes, both the first and second access modes can have a certain level of security and speed, but at least one of the security and speed of the two access modes can be different. For example, when the first access mode is the high-security access mode, and the second access mode is the high-speed access mode, the first access mode can have higher security than the second access mode, and the second access mode can have a higher speed than the first access mode.

Second, when the target access mode is the first access mode (high-security access mode), an access control signal matching the first access mode for the first storage device can be different from an access control signal matching the first access mode for the second storage device. That is, the access control signals of the two storage devices matching the first access mode can be different.

When the target access mode is the second access mode (high-speed access mode), a third access control signal for the first storage device matching the second access mode can be the same as a fourth access control signal for the second storage device matching the second access mode. That is, the access control signals for the two storage devices matching the second access mode can be the same.

In the same access mode, whether the access control signals for the two storage devices are the same or different refers to the signal time sequences being same or different, which is described below.

Furthermore, when the target access mode is the first access mode (high-security access mode), the data accessed from the first storage device based on the first access control signals can be the same as the data accessed from the second storage device based on the second access control signal.

When the target access mode is the second access mode (high-speed access mode), the data accessed from the first storage device based on the third access control signals can be different from the data accessed from the second storage device based on the fourth access control signal.

If the command carried in the data access request is a read command, it indicates that data needs to be read from the two storage devices. If the command carried in the data access request is a write command, it indicates that data needs to be written into the two storage devices. For the first access mode, the data read from the two storage devices or the data written into the two storage devices can be the same. For the second access mode, the data read from the two storage devices or the data written into the two storage devices can be different.

The difference between the two access modes can at least improve the efficiency of accessing the two or more storage devices.

The access scenario shown in FIG. 2 is taken as an example to describe the data access method.

As shown in FIG. 2, for example, the data access device includes two cores (Core 1 and Core 2), and M storage devices include Flash 1 and Flash 2. Core 1 is connected to Flash 1 via Interface 1 (Port A), and Core 2 is connected to Flash 2 via Interface 2 (Port B).

The external device may have the access need for the two Flashes and can send a data access request to the data access device. In some embodiments, the two cores can send the data access requests. The two cores can determine the target access modes for Flash 1 and Flash 2 based on the attributes of the access addresses in the data access requests. For specific determination processes, reference can be made to the above description, which is not repeated here.

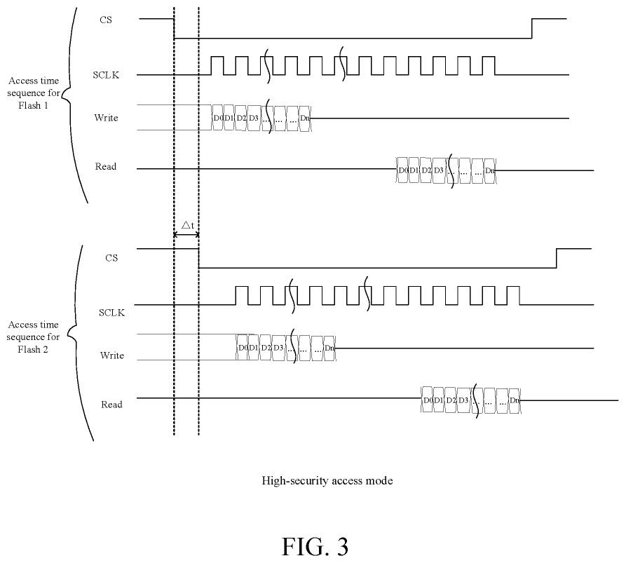

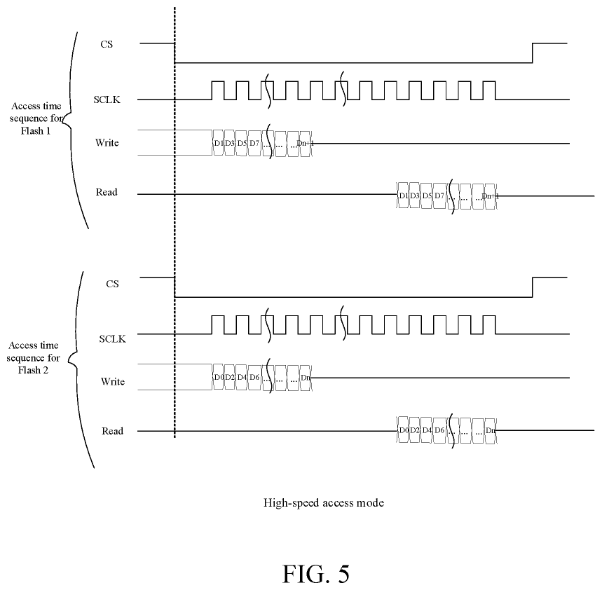

As shown in FIG. 3 and FIG. 5, the access control signals for the two Flashes include chip selection signals (CS) for the two cores to select the Flashes connected to the two cores, respectively, and clock signals (SCLK) output by the two cores for the two Flashes connected to the two cores, respectively.

In some embodiments, a CS can be active at a low level. That is, when the core pulls the CS low, the Flash connected to the core can be selected, and the core can access the Flash. When the CS is in the low level, the core outputs a SCLK signal to the Flash connected to the core. For example, when the CS transforms from a high level to the low level and is stabilized in the low level (maintaining the low level for a while), the core can send the SCLK signal to the Flash.

In some embodiments, the data access device can have an internal clock. The internal clock signal of the data access device can be used as the SCLK signal. In some other embodiments, a signal obtained by processing the internal clock signal of the data access device through a certain process such as dividing, phase flipping, etc., can be used as the SCLK signal. When an ascending edge and/or a descending edge of the SCLK signal arrives, the determined data can be written into the access address of the Flash or read from the access address of the Flash.

The data access request can also carry access commands for the two Flashes. The access commands can be read commands (Read) or write commands (Write). If the access commands are the read commands, the data access device needs to read data from the access addresses of the two Flashes. Then, the data access device can send the read data to the external device. If the access commands are the write commands, the data access device needs to write the data determined by the external device into the access addresses of the two Flashes. When the access commands are the write commands, the data access request can carry the data that needs to be written into the two Flashes.

A single data access request can typically request to access data at the plurality of access addresses in the Flashes. That is, the single data access request can usually request to access a plurality of pieces of data. The access addresses in the data access request can be typically a plurality of addresses with consecutive numbers, such as access addresses A000 to A100. The data access request can be a request to access the data at each address of the access addresses A000 to A100.

If the target access mode for the two Flashes is determined to be the high-security access mode based on the attributes of the access addresses, Core 1 can access the data at the access addresses in Flash 1 according to the first access control signal for Flash 1 that matches the high-security access mode. Core 2 can access the data at the access addresses of Flash 2 according to the second access control signal for Flash 2 that matches the high-security access mode.

In the high-security access mode, the SCLK and CS signals of the access time sequence diagram for Flash 1 in FIG. 3 are considered as the first access control signal for the first storage device that matches the first access mode. The SCLK and CS signals of the access time sequence diagram for Flash 2 in FIG. 3 are considered as the second access control signal for the second storage device that matches the first access mode. Thus, the two access control signals (the first access control signal and the second access control signal) in the high-security access mode are different and have a certain time delay. The CSs of the two Flashes are pulled low at different moments. When the CSs of the two Flashes are pulled low, the two cores send SCLK signals with the same attribute to the two Flashes. The attributes of the signals being the same can indicate that the signal cycles, frequencies, duty cycles, and phases of the SCLK signals output by the two Flashes are the same.

In the high-security access mode, the two cores can access the data of the Flashes connected to the two cores, respectively, in a time-divided access method. The time-divided method can mean that a certain time difference exists for the two cores to pull the CSs. In the time sequence diagram shown in FIG. 3, after core 1 pulls the CS of Flash 1 low, core 2 pulls the CS of Flash 2 low after Δt. Δt can be equal to one, two, or a plurality of SCLK signal cycles. In some other embodiments, after core 2 pulls the CS of Flash 2 low, core 1 can pull the CS of Flash 1 low after Δt, which is not limited here.

If Core 1 pulls down the CS signal for Flash 1 at the same time as Core 2 pulls down the CS signal for Flash 2, Core 1 and Core 2 can synchronously access the data in the Flashes connected to Core 1 and Core 2, respectively. In the synchronous access mode, at the same access time, the two cores can access data at the same address in the two Flashes, which can cause the following problem. If the voltage of the data access device suddenly increases at a certain moment (after a momentary increase, the voltage returns to a stable state), the instability of this voltage can cause instability in the CS and/or SCLK signals. The instability of access control signals can cause the same access error at the same access time. For example, at access time A, both Core 1 and Core 2 should read data from address A008 in Flash 1 and Flash 2, but both incorrectly read data from address A009. This error can lead to simultaneous errors in data read synchronously by both Core 1 and Core 2. However, since Core 1 and Core 2 read the same incorrect data, which is the same error data, the data access device cannot recognize whether the read data is the data required by the external device, i.e., whether the read data is the correct data.

To solve this problem, in some embodiments, the two cores can access the data of the Flashes connected to the two cores, respectively, in the time-divided access method. In the time-divided access method, at the same access time, the two cores can access data at different addresses in the two Flashes. For example, for access time A with a sudden voltage increase, Core 1 should read data from address A008 in Flash 1, but incorrectly read data from address A009. Core 2 should read data from address A003 in Flash 2, but incorrectly read data from address A004. In the time-divided access method, such a momentary voltage increase can cause Core 1 to incorrectly read data from address A008 in Flash 1. However, since the voltage quickly returns to normal, Core 2 will not be caused to incorrectly read data from address A008 in Flash. When such a sudden voltage increase occurs, the time-divided access method can ensure that the access results for the data at the same address in the two Flashes by the two cores are inconsistent. For example, the data read by the two cores from the same address in the two Flashes is different. Based on the inconsistency in the access results of the two cores for the same address in the two Flashes, whether the data access error occurs can be determined.

Compared to the synchronous access method, the time-divided access method in the high-security access mode of embodiments of the present disclosure not only can enable efficient access to two or more storage devices but also effectively identify whether an error exists in data access. In the high-security access mode, the data in the two storage devices can be the same, which is equivalent to performing a plurality of backups on the data. Thus, the safety of the data can be ensured, and the problem of abnormal access to the data due to one of the storage devices being damaged can be effectively avoided. The time-divided access method can be used to recognize whether the storage device has a malfunction.

Taking access addresses A000 to A100 as an example, in the high-security access mode, if the access command is a write command (Write), and a plurality of pieces of data, such as D0, D1, . . . , and Dn need to be written, where n is a positive integer greater than or equal to 1. Then, Core 1 can write data D0 to address A000 in Flash 1, data D1 to address A001 in Flash 1, and data Dn to address A0On in Flash 1. Core 2 can write data D0 to address A000 in Flash 2, data D1 to address A001 in Flash 2, and data Dn to address A0On in Flash 2.

If the access command is a read command (Read), Core 1 can read data D0 from address A000 in Flash 1, data D1 from address A001 in Flash 1, and data Dn from address A00n in Flash 1. Core 2 can read data D0 from address A000 in Flash 2, data D1 from address A001 in Flash 2, and data Dn from address A0On in Flash 2.

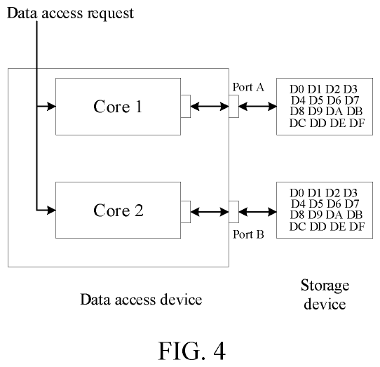

In the high-security access mode, Core 1 accessing Flash 1 and Core 2 accessing Flash 2 can be regarded as two independent access systems. As shown in FIG. 4, the data accessed by the two independent access systems can be the same, i.e., D0D1D2 . . . Dn. That is, the data accessed by Core 1 based on the first access control signal for the first storage device can be the same as the data accessed by Core 2 based on the second access control signal for the second storage device. The two access systems can perform accesses in the time-divided access method, respectively. By performing the time-divided access by the two access systems in the time-divided access method, the problem of being unable to recognize the access error caused by the same interference at the same access time.

If, based on the attributes of the access addresses, the target access modes for the two Flashes can be determined to be the high-speed access mode. Then, core 1 can access the data at the access addresses of Flash 1 according to the third access control signal that matches the high-speed access mode for Flash 1. Core 2 can access the data at the access addresses of Flash 2 according to the fourth access control signal that matches the high-speed access mode for Flash 2.

In the high-speed access mode, the SCLK and CS signals in the access time diagram for Flash 1 shown in FIG. 5 can be considered as the third access control signal that matches the second access mode for the first storage device. The SCLK and CS signals in the access time diagram for Flash 2 shown in FIG. 5 can be considered as the fourth access control signal that matches the second access mode for the second storage device. In the high-security access mode, the two access control signals (the third and fourth access control signals) can be the same. The CS signals for both Flashes can be pulled low at the same time. Furthermore, when the CS signals of the two Flashes are pulled down, the two cores can simultaneously output the SCLK signals with the same attribute as the two Flashes.

In the high-speed access mode, if the access command is a write command (Write), the data to be written to the two Flashes can be split into two portions of data. Core 1 can write a first portion of data into Flash 1 according to the third access control signal. Core 2 can write a second portion of data into Flash 2 according to the fourth access control signal. If the access command is a read command (Read), core 1 can read the data at the access address of Flash 1 according to the third access control signal, and core 2 can read the data at the access address of Flash 2 according to the fourth access control signal, reads the data in the access address of Flash 2. Then, the data read by Core 1 and the data read by Core 2 can be combined and sent to the external device to provide the data needed by the external device.

For example, taking access addresses A000 to A010 as an example, in the high-speed access mode, if the access command is a write command (Write), and the data to be written is D0, D1, . . . , Dn. According to the positions (odd number position and even number position) of the different pieces of the data to be written, the data to be written can be split into the first portion of data (including D1, D3, D5, etc.) and the second portion of data (including D0, D2, D4, etc.). Core 1 can write the first portion of data into addresses A000 to A010 of Flash 1 according to the third access control signal. Core 2 can write the second portion of data into addresses A000 to A010 in Flash 2 according to the fourth access control signal. With the written solution in a splitting method, data written can be faster, and the data can be written effectively.

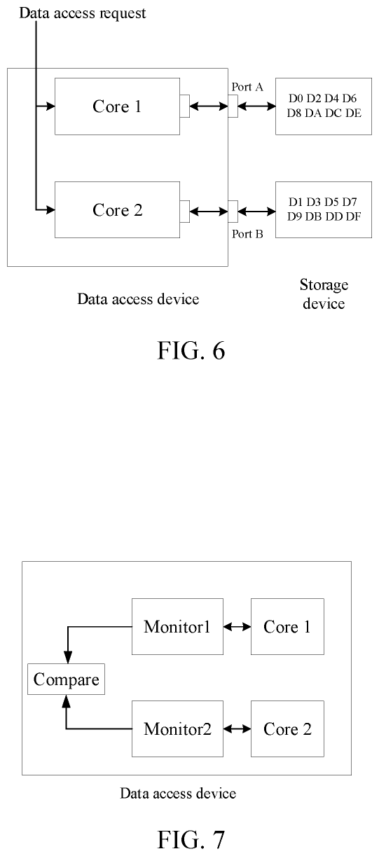

For example, as shown in FIG. 6, taking access addresses A000 to A010 as an example, in the high-speed access mode, if the access command is a read command (Read), core 1 can read the data from addresses A000 to A010 in Flash 1 according to the third access control signal. For example, the read data can include D1, D3, D5, etc., as the first portion of data. Core 2 can read the data from addresses A000 to A010 in Flash 2 according to the fourth access control signal. For example, the read data can include D0, D2, D4, etc., as the second portion of data. After being combined, the first portion of data can be used as the data at the odd number position, and the second portion of data can be used as the data at the even number position. The first portion of data and the second portion of data can be combined to obtain the combined data D0, D1, D2, . . . , and Dn. The read solution in a combined method can accelerate data reading to realize effective reading.

In the high-speed access mode of embodiments of the present disclosure, data writing and reading can be accelerated, and two or more storage devices can be accessed effectively.

In the time diagrams shown in FIG. 3 and FIG. 5, for the read or write command in the data access request, it can be pre-agreed to read or write data at which SCLK arrives. For example, it can be agreed to write data when the first SCLK arrives and read data when the eighth SCLK arrives. It can also be pre-agreed to read or write how many pieces of data within each SLCK. FIG. 3 and FIG. 5 show that two pieces of data are read or written within each SCLK. One piece of data can be read or written at each of the high level and low level of the SCLK. with one data item read or written during each high level and low level of SLCK.

In some embodiments, if the technology of the present disclosure is applied to a driving device, during the initial startup phase of the driving device, the startup safety of the device may need to be ensured. Δt this time, the high-security access mode can be used to access the data required for the startup of the driving device to safely start the driving device. During the driving phase after starting the driving device, the real-time performance of the steering and speed control of the driving device may need to be ensured. Thus, the data required for the steering and speed control can be accessed in the high-security access mode to steer and control the speed quickly.

In some embodiments, as shown in FIG. 7, the data access device also includes two monitors (Monitor 1 and Monitor 2) and a comparison device (compare). The two monitors can be configured to monitor the data access process of the two cores to the two storage devices. Monitor 1 and Monitor 2 can be configured to monitor whether the data access device is working normally in any access mode, such as whether Core 1 and Core 2 are in a normal working status, whether Core 1 and Core 2 access data according to the access control signals, and whether the access time sequence to the two storage devices is normal. The content monitored by the monitors can be used as monitoring information.

Monitor 1 and Monitor 2 can be configured to read the data accessed by the two cores, and the comparison device can be configured to compare whether the data accessed by the two cores is consistent. For example, the request can be made to read data from addresses A000 to A010 in the two storage devices in the high-security access mode, monitor 1 can send the data read by Core 1 from addresses A000 to A010 in Flash 1 to the comparison device. Monitor 2 can send the data read by Core 2 from addresses A000 to A010 in Flash 2 to the comparison device. The comparison device can then perform a one-by-one comparison for the data. Since, in the high-security access mode, the data stored at the same address in the two storage devices should be the same, if the comparison device detects inconsistency among the data, for example, if the data read by Core 1 from A000 in Flash 1 is different from the data read by Core 2 from A000 in Flash 2, an access error can be determined, and an interrupt signal can be generated for warning.

Here, the comparison device is intended to determine whether the access results of the two cores to the same address in two different Flash devices have consistency to determine whether the access error exists according to the consistency or inconsistency.

In summary, in embodiments of the present disclosure, the monitors can be configured to monitor the data access process to obtain the monitoring information. The comparator can obtain the monitoring results for performing data access on the storage devices and determine whether a second warning signal is generated based on the monitoring results. In some embodiments, the comparison device can obtain a monitoring result for each type of monitoring information according to each type of monitoring information monitored by the monitors and determine whether to generate the warning signal according to the monitoring results. If the comparison device detects that the data of the same access address of the two storage devices accessed by the two cores is inconsistent, an interrupt signal can be generated for a warning. The interrupt signal can be used as the second warning signal.

The above solution is described by taking an example of the data access device with two cores and two storage devices. In some embodiments, three, four, or another appropriate number of cores and storage devices can be included. To effectively access the storage devices the number of cores can be set consistently with the number of storage devices.

In some embodiments, the data access device shown in FIG. 2, FIG. 4, and FIG. 6 can be a controller. Interfaces (Port A and Port B) of the controller can support interfaces with any reasonable interface type, such as an I2C interface, an SPI interface, or an xSPI interface.

The technical solution of the present disclosure can implement two access modes at the hardware level, which can ensure the effectiveness of the data access at the hardware level. The effective data access solution at the hardware level can better, faster, and more securely provide the software level with the required data.

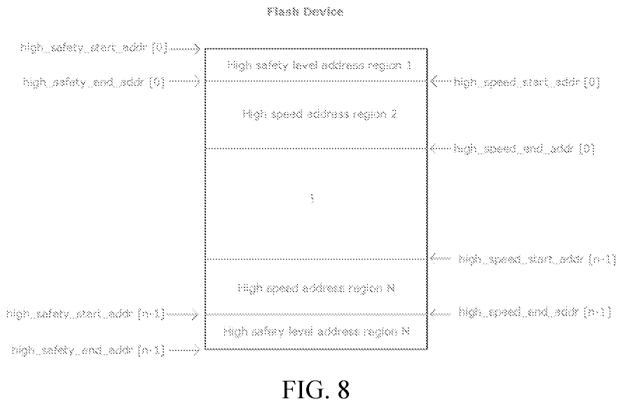

FIG. 8 illustrates a diagram of dividing the Flash into two types of regions. The storage device is divided into a high-security address region and a high-speed address region. Within the same storage device, the number of high-security address regions and high-speed address regions can be N, where N is an integer greater than or equal to 1.

Each divided high-security address region includes the start address and end address of the region. For example, the start (storage) address of an n-th high safety level address region is High_safety_start_addr[n-1], and the end address is High_safety_end_addr[n-1], where n is an integer greater than or equal to 1, and n is less than or equal to N. Each divided high-speed address region can include the start address and end address of the region. For example, the start address of an n-th high-speed region is High_speed_start_addr[n-1], and the end address is High_speed_end_addr[n-1]. In the storage device, addresses from the start address to the end address in a certain region can be used as the storage addresses of the storage device in the region.

High-security address regions can be or not be neighboring to each other, high-speed address regions can be or not be neighboring to each other, and the high-security address region and the high-speed address region can be or not be neighboring to each other, which are according to specific situations. FIG. 8 is only an illustration of the division. Any appropriate division should be within the scope of the present disclosure.

When the storage device is divided into two types of regions in a fixed division method, attribute information can be configured for the storage devices of the regions. When the external device generates the data access request, the data access request can carry the access address that is to be accessed. According to the attribute information that is pre-configured for the access address, whether the access address is accessed in the high-security access mode or the high-speed access mode can be determined. The method of fixedly dividing the storage device into two types of storage areas can be feasible and easy to implement.

Different from the fixed division of the storage region of the storage device, embodiments of the present disclosure further provide a method for flexibly determining the attribute of the storage address according to the access mode used when the storage address of the storage device was accessed in the history.

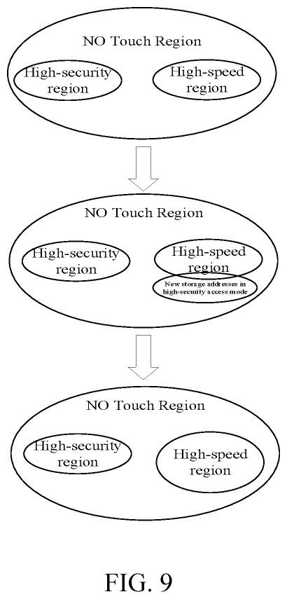

Referring to FIG. 9, during an initial phase (not performing any address access), all storage addresses in the Flash are considered as no-touch addresses. A region formed by the no-touch addresses is the no-touch region. Thus, when the external device generates the initial data access request, the data access request can carry the access address that is to be accessed and the access mode for accessing the access address. If the access mode for accessing a certain no-touch address for the first time is the high-security access mode (or high-speed access mode), the address can be considered to transform from the no-touch address into the high-security address (or high-speed address). The attribute information configured for the address can indicate that the address can be accessed in the high-security access mode. As the data access requests continue to increase, the no-touch region is getting smaller and smaller, and the high-security region and the high-speed region are getting larger.

For the same storage address, the attribute information can be configured for the address according to the access mode used for accessing the address for one or a plurality of times in the history. If the address is accessed in the high-security access mode at the nearest time of the first time in history, the storage address can be configured with the attribute information indicating that the address can be accessed in the high-security access mode.

The solution is a flexible configuration solution of the attribute information of the storage addresses based on the history access mode for the storage addresses. After the access address is configured with the attribute information according to the history access mode, the access modes carried in the data access requests when subsequently performing one or a plurality of times of accesses on the address may need to be the same as the access mode indicated in the attribute information (configured according to the history access mode). Thus, the address can be accessed in the correct access mode.

In a data access request, if the target access mode determined based on the historical access mode of the access address differs from the predetermined access mode included in the data access request for the address, a first warning signal can be generated.

For example, taking the addresses A000 to A0010 as an example, the address can be determined to be accessed in the high-security access mode according to the history access mode of the address. In the data access request for the address, the data access request can indicate that the address can be accessed in the high-speed access mode. That is, the target access mode determined under the data access request based on the history access mode can be different from the access mode carried in the data access request. To avoid the situation that the address cannot be accessed due to the target access mode and the access mode carried in the data access request being different, the first warning signal can be generated for notification. The access mode carried in or indicated by the data access request can be used as the pre-determined access mode.

In some embodiments, if a history access mode based on the access address exists within a data access request, and the determined target access mode differs from the predetermined access mode included in the data access request for the access address, the data access can be performed on the storage device based on the access control signals matching the predetermined access mode for the storage devices.

In some embodiments, the attribute information for the same storage address can be changed. For example, the attribute information for storage addresses A000 to A0010 originally indicating performing access in the high-security access mode can be changed into attribute information indicating performing access in the high-speed access mode. Thus, the data access can be performed on the storage addresses A000 to A0010 in the changed access mode, i.e., the high-speed access mode.

For example, the attribute information configured for the address according to the history access mode of the storage addresses A000 to A0010 can indicate that the address can be accessed in the high-security access mode. Assume that the data stored in the storage addresses A000 to A0010 can be D0, D2, D4, and D6. After the external device determines that the data stored in the storage addresses A000 to A0010 is D0, D2, D4, and D6, the data may be no longer read in the high-security access mode. The access mode of the storage address A000 to A0010 and the data stored in the addresses may need to be changed. Then, in the next data access request for the storage addresses A000 to A0010, the predetermined access mode carried in the data access request can be the high-speed access mode, which is different from the high-security access mode obtained according to the attribute information (through the history access mode), the storage addresses A000 to A0010 can be accessed in the high-speed access mode. Taking the access command as a write command, other data, such as D1, D3, D5, and D7, determined by the external device can be written into A000 to A0010 in the high-speed access mode for subsequent reading.

The solution of performing the data access on the storage devices based on the access control signals matching the pre-determined access mode for the storage devices can realize the flexible access of the storage devices, be feasible, and practical.

The first warning signal can be generated when the target access mode of the data access request determined based on the history access mode is different from the access mode carried by the history access mode to prompt the access error. In addition, in the application scenario of the target access mode of the data access request determined based on the history access mode being different from the access mode carried in the data access request, whether to generate the first warning signal can be determined based on the determination result of whether the access address of the data access request is the address of the storage device corresponding to the pre-determined access mode when the data access is performed on the storage devices based on the access control signals matching the pre-determined access mode for the storage devices.

For example, the access addresses can be A000 to A0010. In one data access request for the storage addresses A000 to A0010, the carried (pre-determined) access mode is the high-speed access mode, which differs from the high-security access mode based on attribute information obtained from the history access modes. Then, the storage addresses A000 to A0010 can be accessed in the high-speed access mode.

The storage device can include the storage addresses in the high-security region and/or the storage addresses in the high-speed region before the data access request, and the addresses A000 to A0010 of the storage device can be in the high-security region not in the high-speed region before the data access request according to the attribute information (obtained through the history access mode). Thus, the addresses A000 to A0010 may not be the addresses of the region corresponding to the pre-determined access mode, and an interrupt signal can be generated and can be used as the first warning signal.

Meanwhile, to avoid the access error for the subsequent accesses to the addresses A000 to A0010, the original attribute information of the addresses A000 to A0010 indicating the high-security access mode can be updated to the attribute information indicating the high-speed access mode. That is, the addresses A000 to A0010 were originally used as the addresses in the high-security region (high-security addresses) and are now used as the addresses in the high-speed region (high-speed addresses).

Since the role of the addresses A000 to A0010 (from the high-security addresses to the high-speed addresses) changes, the number of storage addresses of the storage device in the high-security region decreases, and the number of storage addresses in the high-speed region increases before the data access request. The coverage of the high-security region and high-speed region of the storage device can change with the data access request. Therefore, compared to the solution of performing the fixed division on the storage device into the two types of regions, the present solution can realize flexible division for different regions of the storage device, adapt to actual situations in the application, and be practical and flexible.

In some embodiments, when the fixed division is performed on the storage device according to different regions, the storage addresses of the storage device in the high-security region or the storage addresses of the storage device in the high-speed region can be flexibly updated with address roles according to the pre-determined access mode carried in the data access request. Thus, the address roles can be flexibly updated to realize the flexibility in updating the address roles.

As a highly reliable storage device, the Flash can be applied in related technologies, such as the automotive industry or artificial intelligence. With the technical solution of the present disclosure, different access modes for accessing the Flash can be realized, and the Flash can be effectively accessed. When the data access request carries the pre-determined access mode, the high-security region and the high-speed region of the Flash can be updated according to the actual access situations.

The technical solution of the present disclosure has the following beneficial effects.

Firstly, two or more Flashes are provided in the present disclosure. According to the actual situation, the high-security access mode or the high-speed access mode can be flexibly adopted to access the Flashes. Thus, the access to the Flashes is no longer limited to the read and write performance of the Flashes. The Flashes can be effectively accessed by increasing the number of the Flashes and selecting different access modes.

Secondly, in the high-security access mode, the data in the two storage devices is the same. If the data at the same storage address of the two Flashes accessed by the two cores is different, the difference can be caused by a failure in one of the storage devices. The access process in the high-security access mode of embodiments of the present disclosure can be used as a method of detecting whether the Flash fails.

In some embodiments, more cores can be provided in the data access device to be connected to Flash devices of different manufacturers. Thus, multiple levels of protection can be realized for stored data.

Thirdly, in the technical solution of the present disclosure, two access modes are provided for accessing the Flashes. One of the access modes can be flexibly selected according to the actual needs. In a scenario having a high-speed requirement, the Flash can be accessed in the high-speed access mode. In a scenario having a high-security requirement, the Flash can be accessed in the high-security access mode.

By selecting or switching the high-speed access mode and the high-security access mode, the Flash can be effectively accessed using hardware resources, such as the cores, the monitors, and comparison devices, at a hardware level.

The present disclosure also provides embodiments of a data access device. As shown in FIG. 10, the device includes a first acquisition unit 701, a determination unit 702, and an access unit 703.

The first acquisition unit 701 can be configured to obtain the data access request for the M storage devices, where M is an integer greater than or equal to 2.

The determination unit 702 can be configured to determine the target access mode for the M storage devices based on the data access request.

The access unit 703 can be configured to perform data access on the storage devices based on the access control signals matching the target access mode for the storage devices.

The target access mode can include the first access mode and the second access mode. The access security and/or access speed generated when the data access is performed on the storage devices in the first access mode can be different from the access security and/or the access speed generated in the second access mode.

In some embodiments, the target access mode can be the first access mode. The storage devices can include the first storage device and the second storage device. The access security of the first access mode can be higher than the access security of the second access mode.

In some embodiments, the data accessed based on the first access control signal for the first storage device can be the same as the data accessed based on the second access control signal for the second storage device.

In some embodiments, the target access mode can be the second access mode. The storage devices can include the first storage device and the second storage device. The third access control signal matching the second access mode for the first storage device can be the same as the fourth access control signal matching the second access mode for the second storage device. The access speed in the second access mode can be higher than the access speed in the first access mode.

In some embodiments, the data accessed based on the third access control signal for the first storage device can be different from the data accessed based on the fourth access control signal for the second storage device.

In some embodiments, the data access request can include the access addresses for the M storage devices. The determination unit 702 can be configured to determine the target access mode for the M storage devices based on the attributes of the access addresses.

In some embodiments, the attributes of the access addresses can be obtained by dividing the storage regions of the storage devices into at least two types. The first type storage region can correspond to the first access mode, and the second type storage region can correspond to the second access mode.

In some embodiments, the attributes of the access addresses can be determined according to the history access modes of the access addresses.

In some embodiments, when the target access mode determined based on the history access mode of the access addresses for the M storage devices is different from the pre-determined access mode of the access addresses included in the data access request, the access unit 703 can be configured to perform data access on the storage devices based on the access control signals matching the predetermined access mode for the storage devices.

In some embodiments, the device can further include a first warning unit configured to generate the first warning signal when the target access mode determined based on the history access mode of the access addresses for the M storage devices is different from the predetermined access mode carried in the data access request for the access addresses.

In some embodiments, the device can further include a second acquisition unit and a second warning unit.

The second acquisition unit can be configured to obtain the monitor results for performing the data access on the storage devices.

The second alarm unit can be configured to determine whether to generate the second warning signal based on the monitoring results.

In the data access device of embodiments of the present disclosure, since the principle of the data access device solving the problem is similar to the above data access method, for the implementation process and the implementation principle of the data access device, reference can be made to the implementation process and the implementation principle of the above method, which is not repeated here.

According to embodiments of the present disclosure, the present disclosure further provides a vehicle device including at least the above chip.

According to embodiments of the present disclosure, the present disclosure can further provide the data access device and a readable storage medium.

The data access device can include at least one processor and a memory communicatively connected to the at least one processor. The memory stores a command that can be executed by the at least one processor. The command can be executed by the at least one processor to cause the at least one processor to perform the above data access method.

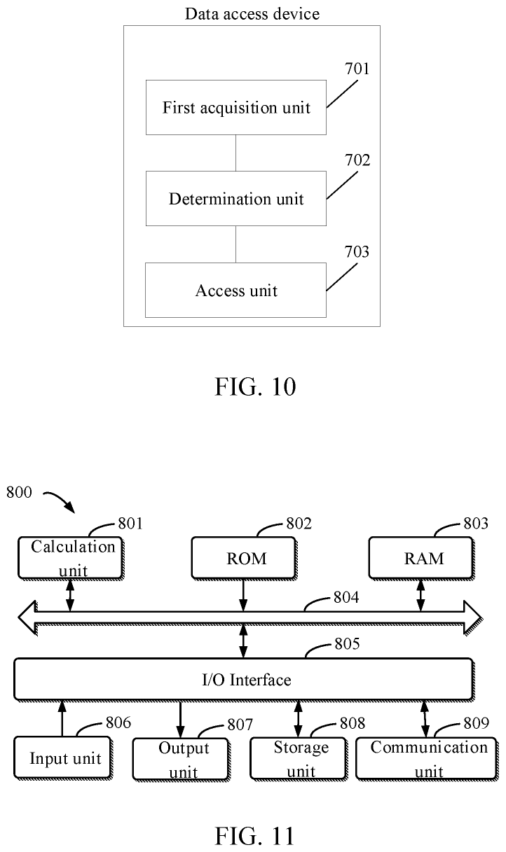

FIG. 11 illustrates a schematic structural diagram of a data access device 800 according to some embodiments of the present disclosure.

.As shown in FIG. 11, the device 800 can include the calculation unit 801 configured to perform appropriate actions and processes according to the computer program in the read-only memory (ROM) 802 or load the computer program into the random access memory (RAM) 803. The RAM 803 can also store the programs and data required by the operations of the storage devices 800. The calculation unit 801, ROM 802, and RAM 803 can be interconnected to each other through the bus 804. The input/output (I/O) interface 805 can be directly connected to the bus 804.

A plurality of members of the device 800 can be connected to the I/O interfaces 805, which includes an input unit 806, such as the keyboard, the mouse, etc., an output unit 807, such as different types of monitors and loudspeakers, a storage unit 808, such as a magnetic disk, optical disks, and a communication unit 809, such as a network card, a modem, and a wireless communication transceiver. The communication unit 809 can allow the device 800 can exchange information/data with another device through a computer network and/or various telecommunication networks.

The calculation unit 801 can be a general-purposed and/or dedicated processing assembly having the processing and calculation abilities. In some embodiments, the calculation unit 801 can include but is not limited to a central processing unit (CPU), a graphics processing unit (GPU), a dedicated artificial intelligence (AI) calculation chip, calculation units for running machine learning model algorithms, a digital signal processor (DSP), and any appropriate processor, controller, and microcontroller. The calculation unit 801 can perform the method and processes described above, for example, the data access method. In some embodiments, the data access method can be implemented by a computer software program, which is tangibly embodied in a computer-readable medium, such as a storage unit 808. In some embodiments, all or a part of the computer program can be loaded into and/or installed on the device 800 via the ROM 802 and/or the communication unit 809. When the computer program is loaded into the RAM 803 and executed by the calculation unit 801, one or a plurality of steps of the data access method above can be performed. In some other embodiments, the calculation unit 801 can be configured to execute the data access method through any other appropriate methods, for example, with the firmware.

In embodiments of the present disclosure, the systems and technologies described above can be realized in a digital electronic circuit system, an integrated circuit system, a field-programmable gate array (FPGA), an application-specific integrated circuit (ASIC), an application-specific standard product (ASSP), a system-on-chip (SOC) system, a complex programmable logic device (CPLD), computer hardware, firmware, software, and/or a combination thereof. In some embodiments, the one or the plurality of computer programs can be executed and/or explained in the programmable system including at least a programmable processor. The programmable processor can be a dedicated or general-purpose processor, which can receive data and instructions from the storage system, the at least one input device, and the at least one output device. Moreover, the data and the instruction can be transferred to the storage system, the at least one input device, and the at least one output device.

In the context of the present disclosure, a computer-readable medium can be a tangible medium and include or store a program for use by or in connection with an instruction execution system, apparatus, or device. The computer-readable medium can be a computer-readable signal medium or a computer-readable storage medium. The computer-readable medium can include but is not limited to electronic, magnetic, optical, electromagnetic, or semiconductor systems, apparatuses, or devices, or a combination thereof. In some embodiments, the computer-readable storage medium can further include electrical connection based on one or a plurality of wires, a portable computer disc, a hard drive, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

The above description illustrates some embodiments of the present disclosure. However, the scope of the present disclosure is not limited to this. Those skilled in the art can easily think of modifications or replacements, which are within the scope of the present disclosure. Thus, the scope of the present disclosure should be subject to the scope of the claims.

What is claimed is:

1. A data access method comprising:
obtaining a data access request for M storage devices, M being an integer greater than or equal to 2;
determining a target access mode for the M storage devices based on the data access request;
performing data access on the storage devices based on access control signals matching the target access mode for the storage devices;
wherein:
the target access mode includes a first access mode and a second access mode; and
access security and/or access speed generated when the data access is performed on the storage devices in the first access mode is different from access security and/or access speed generated in the second access mode.

2. The method according to claim 1, wherein:
the target access mode is the first access mode, and the storage devices include a first storage device and a second storage device;
a first access control signal matching the first access mode for the first storage device is different from a second access control signal matching the first access mode for the second storage device; and
the access security of the first access mode is higher than the access security of the second access mode.

3. The method according to claim 2, wherein data accessed based on the first access control signal for the first storage device is the same as data accessed based on the second access control signal for the second storage device.

4. The method according to claim 1, wherein:
the target access mode is the second access mode, and the storage devices include a first storage device and a second storage device; and
a third access control signal matching the second access mode for the first storage device, is the same as a fourth access control signal matching the second access mode for the second storage device, the access speed of the second access mode being higher than the access speed of the first access mode.

5. The method according to claim 4, wherein data accessed based on the third access control signal for the first storage device is different from data accessed based on the fourth access control signal for the second storage device.

6. The method according to claim 1, wherein:
the data access request includes access addresses for the M storage devices; and
determining the target access mode for the M storage devices based on the data access request includes determining the target access mode for the M storage devices based on attributes of the access addresses.

7. The method according to claim 6, wherein:
the attributes of the access addresses are determined by dividing storage regions of the storage devices into at least two types; and
a first type storage region corresponds to the first access mode, and a second type storage region corresponds to a second access mode.

8. The method according to claim 6, wherein the attributes of the access addresses are determined through a history access mode of the access addresses.

9. The method according to claim 8, wherein in response to the target access mode determined based on the history access mode of the access addresses for the M storage devices being different from a predetermined access mode included in the data access request, performing the data access on the storage devices based on the access control signals matching the target access mode for the storage devices includes:
performing the data access on the storage devices based on the access control signals matching the predetermined access mode for the storage devices.

10. The method according to claim 8, wherein in response to the target access mode determined based on the history access mode of the access addresses for the M storage devices being different from the predetermined access mode included in the data access request for the access addresses, a first warning signal is generated.

11. The method according to claim 1, further comprising:
obtaining a monitoring result for performing the data access on the storage devices; and
determining whether to generate a second warning signal based on the monitoring result.

12. A data access device comprising:
one or more processors; and
one or more memories communicatively connected to the one or more processors and storing an instruction that, when executed by the one or more processors, causes the one or more processors to:
obtain a data access request for M storage devices, M being an integer greater than or equal to 2;
determine a target access mode for the M storage devices based on the data access request;
perform data access on the storage devices based on access control signals matching the target access mode for the storage devices;
wherein:
the target access mode includes a first access mode and a second access mode; and
access security and/or access speed generated when the data access is performed on the storage devices in the first access mode is different from access security and/or access speed generated in the second access mode.

13. The device according to claim 12, wherein:
the target access mode is the first access mode, and the storage devices include a first storage device and a second storage device;
a first access control signal matching the first access mode for the first storage device is different from a second access control signal matching the first access mode for the second storage device; and
the access security of the first access mode is higher than the access security of the second access mode.

14. The device according to claim 13, wherein data accessed based on the first access control signal for the first storage device is the same as data accessed based on the second access control signal for the second storage device.

15. The device according to claim 12, wherein:
the target access mode is the second access mode, and the storage devices include a first storage device and a second storage device; and
a third access control signal matching the second access mode for the first storage device, is the same as a fourth access control signal matching the second access mode for the second storage device, the access speed of the second access mode being higher than the access speed of the first access mode.

16. The device according to claim 15, wherein data accessed based on the third access control signal for the first storage device is different from data accessed based on the fourth access control signal for the second storage device.

17. The device according to claim 12, wherein:
the data access request includes access addresses for the M storage devices; and
the one or more processors are further configured to determine the target access mode for the M storage devices based on attributes of the access addresses.

18. The device according to claim 17, wherein:
the attributes of the access addresses are determined by dividing storage regions of the storage devices into at least two types; and
a first type storage region corresponds to the first access mode, and a second type storage region corresponds to a second access mode.

19. The device according to claim 17, wherein the attributes of the access addresses are determined through a history access mode of the access addresses.

20. A non-transitory computer-readable storage medium storing an instruction that, when executed by one or more processors, causes the one or more processors to:
obtain a data access request for M storage devices, M being an integer greater than or equal to 2;
a determination unit configured to determine a target access mode for the M storage devices based on the data access request;
an access unit configured to perform data access on the storage devices based on access control signals matching the target access mode for the storage devices;
wherein:
the target access mode includes a first access mode and a second access mode; and
access security and/or access speed generated when the data access is performed on the storage devices in the first access mode is different from access security and/or access speed generated in the second access mode.
